(19) United States
(12) Patent Application Publication
(10) Pub. No.: US 2007/0176761 A1
(43) Pub. Date: Aug. 2, 2007

(54) AGRICULTURAL MOTOR VEHICLE

(76) Inventors: Ludger Hugenroth, Ostbevern (DE); Heinrich Isfort, Duelmen (DE); Herbert Twiefel, Harswewinkel (DE)

Correspondence Address: Striker, Striker & Stenby, 103 East Neck Road, Huntington, NY, 11743, US

(21) Appl. No.: 11/626,528

(22) Filed: Jan. 24, 2007

(30) Foreign Application Priority Data
Jan. 27, 2006 (DE) 10 2006 004 143.7

(51) Int. Cl. B60Q 1/00

(52) U.S. Cl. 340/438

(57) ABSTRACT

An agricultural motor vehicle has at least two drive units which can be operated in a drive train, each of which is capable of outputting the same amount or different amounts of power, each of said drive units includes a unit for recording operating hours; the at least two drive units have a nearly balanced operating-hour ratio within a certain time period. In this manner it is ensured that either working unit does not experience more wear than the other within the time period; this ensures that service work is performed on the two drive units at nearly the same time, during the same service appointment.

### CROSS-REFERENCE TO A RELATED APPLICATION

The invention described and claimed hereinbelow is also described in DE 10 2006 004 143.7, filed Jan. 27, 2006. This German Patent Application, whose subject matter is incorporated here by reference, provides the basis for a claim of priority of invention under 35 U.S.C. 119 (a)-(d).

### BACKGROUND OF THE INVENTION

The present invention relates to an agricultural motor vehicle.

Due to the general evolution of agricultural engineering and the increasing size of fields to be worked, the amount of power required from individual agricultural working machines continues to increase, in order to meet these challenges.

Publication DE 1 780 052 makes known an agricultural motor vehicle with two drive units, in the case of which each of the two drive units is positioned such that, in an actual “one-man” operation, the highest possible rate of work can be attained when devices or machines are installed on this motor vehicle. To balance the output between the two drive units, it is provided that the two drive units can be coupled with each other or, under certain operating circumstances, the output from the two drive machines can be utilized together or separately. To control the two drive units, two control consoles located in mirror-image positions, and a swivel seat, are provided at the operator's platform.

A problem associated with a configuration of this type is that the further drive unit is always engaged as a “power reserve”, which ultimately leads to a situation in which the two drive units do not reach their service intervals at the same time. This results in higher service requirements.

A further agricultural working machine with basic modular, mechanical equipment which makes it possible to build—quickly and in a diverse manner—all of the self-propelled devices and device combinations required in modern agricultural engineering, from simple trailers to a combine harvester, and which includes two drive units which can be connected with each other using a coupling piece is disclosed in DE 30 49 055 A1. This embodiment also has the disadvantage that it is not ensured that the two drive units will reach their service intervals at the same time, thereby resulting in increased service requirements.

### SUMMARY OF THE INVENTION

The object of the present invention, therefore, is to avoid the disadvantages described in the related art and, in particular, to provide a device that makes it possible to reduce the service requirements required for a motor vehicle operated with several drive units.

In keeping with these objects and the others which have become apparent hereinafter, one feature of the present resides, briefly stated, in an agricultural motor vehicle, comprising at least two drive units configured so that they are operatable separately or together in a drive train and outputting a same amount or different amounts of power, each of said drive units including means for recording operating hours, said at least two drive units being configured so that they have a substantially balanced operating-hour ratio within a certain time period.

Another feature of the present invention resides, briefly stated, in an agricultural motor vehicle, comprising at least two drive units operatable separately or together in a drive train and each capable of outputting a same amount or different amounts of power, each of said drive units including means for recording operating hours; a user interface and display unit; and a control device, said control device being connected via a data transmission system with drive-state sensors and/or control devices which contain drive-state data, and said user interface and display unit displaying the operating hours of a particular one of said working units and/or the operating-hour ratio of said at least two drive units.

Given that the at least two drive units have a nearly identical operating-hour ratio within a certain time period, it can be ensured that one of the drive units does not experience a greater amount of wear in the time period; this allows service work to be performed on both drive units at the same time, during the same service appointment, thereby enabling the service requirements for the drive units to be optimized. This effect is particularly great when drive units are used which have different service intervals as indicated by their operating hours, and which are then operated in a manner such that the end of the different service intervals is reached at nearly the same time.

A very exact operating-hour ratio between the at least two drive units can be attained when the operating-hour ratio includes the comparison of the operating hours of the at least two drive units, and when the determination of the operating hours takes into account the operating period and drive-specific state information about the particular drive unit.

An advantageous embodiment of the present invention results when, before the particular drive unit is started up, the operating-hour ratio of the at least two drive units is determined based on a comparison of the operating hours, and, to attain a balanced operating-hour ratio—based on this comparison and with consideration for the power required by the agricultural working machine—the additional power is initially provided by the drive unit with the fewer operating hours, so that the individual working units are loaded in a nearly balanced manner, independently of the power required by the agricultural working machine; this advantageously results in congruent wear of the at least two drive units, thereby making it possible to perform maintenance on both of the drive units nearly simultaneously.

Given that, when more power is required by the agricultural motor vehicle, both of the drive units can provide power and, if less power is required and it can be provided by one drive unit, and the drive unit with the fewer number of operating hours provides it, it is ensured that the at least two drive units become worn evenly even if the power required by the agricultural working machine fluctuates, and it is ensured that the two drive units will require service at the same time.

In an advantageous refinement of the present invention, the drive-specific state information includes engine speed, the fill level of the engine oil, fuel consumption, and engine temperature, so that the operating-hour ratio reflects an exact load ratio of the at least two drive units, so that the two drive units will require service at nearly the same time.

A particularly advantageous suitability for an agricultural application results when the drive units are designed as diesel engines.

Given that the at least two drive units form a “V” shape with each other and include a synchronizing drive, rotational vibrations of the drive units can be advantageously reduced. This effect is even greater when the synchronicity of operation of both drive units is so finely tuned that the vibrations produced by the drive units nearly cancel each other out.

In a further advantageous embodiment of the present invention, the two drive units are offset axially and in parallel, thereby enabling optimal belt guidance for the main drive and further assemblies to be attained.

To efficiently attain a balanced operating-hour ratio between the at least two drive units, it is provided in a further advantageous embodiment that the balancing of the operating-hours ratio is carried out manually by the operator of the agricultural working machine using a user interface and display unit, or automatically by an electronic control unit, using sensors.

To ensure that the service work on the drive units can be carried out efficiently and in a cost-saving manner, the time period in which a balanced operating-hour ratio is to be attained corresponds to the service interval specified by the manufacturer of the drive unit.

Given that the agricultural motor vehicle includes a user interface and display unit, and a control unit, and the control unit is connected via a data transmission system with drive-state sensors and/or control devices which contain drive-state data, and the user interface and display unit displays the operating hours of the particular drive unit, and/or the operating-hours ratio of the at least two drive units, it is easily ensured that the service requirements for a the service intervals can be coordinate by monitoring the number of operating hours, which is now made possible.

The present invention advantageously includes a user interface and display unit, and a control unit. The control unit is connected via a data transmission system with drive-state sensors, and/or control devices which contain drive-state data, and the user interface and display unit displays the number of operating hours of the particular drive unit, and/or the operating-hours ratio of the at least two drive units. The operator is therefore informed of the relevant data.

A particularly advantageous embodiment of the present invention results when the agricultural motor vehicle is designed as a forage harvester, and when one drive unit for operating the working units, and the at least one further drive unit form the ground drive of the motor vehicle; the working units essentially include the chopper drum, the post-fragmentation device, the post-acceleration device, and the intake conveyor mechanisms. This has the advantage, in particular, that the working units can be operated independently of the ground drive. As a result, disturbances in one system do not necessarily affect the rest of the drive train.

A particularly low-maintenance embodiment of the present invention results when the at least two drive units share the same fuel supply. This has the advantage, in particular, that it eliminates the need to provide more than one supply system for the drive units. With regard for reduced service requirements, this effect occurs in particular when the several drive units have only one oil circuit, and this shared oil circuit includes one oil filler neck and one oil drainage device.

A design which reduces the susceptibility to interference and, therefore, service requirements also results due to the fact that a single starting device for a drive unit is assigned to the at least two drive units, and the at least one further drive unit is started up by the drive unit which was started by the starting device.

Since highly diverse supply assemblies are usually connected directly to one drive unit via flange, a further advantageous embodiment of the present invention results these assemblies are located on the drive unit which can be accessed directly, thereby allowing service to be carried out without laborious disassembly work.

In a further advantageous embodiment of the present invention, one of the drive units drives the working units and the ground drive, while the at least one further drive unit supports the braking function of the agricultural vehicle. This has the advantage, in particular, that the motor vehicle can be guided safely when it is driven on the road at high rates of speed, or when it is driven downhill, and it can be stopped quickly if dangerous situations arise.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 shows a self-propelled forage harvester with a front attachment and two drive units, in a side view and a sectional view, in accordance with the present invention.

FIG. 2 shows the rear region of a self-propelled forage harvester, in a schematized top view, in accordance with the present invention.

### DESCRIPTION OF THE PREFERRED EMBODIMENTS

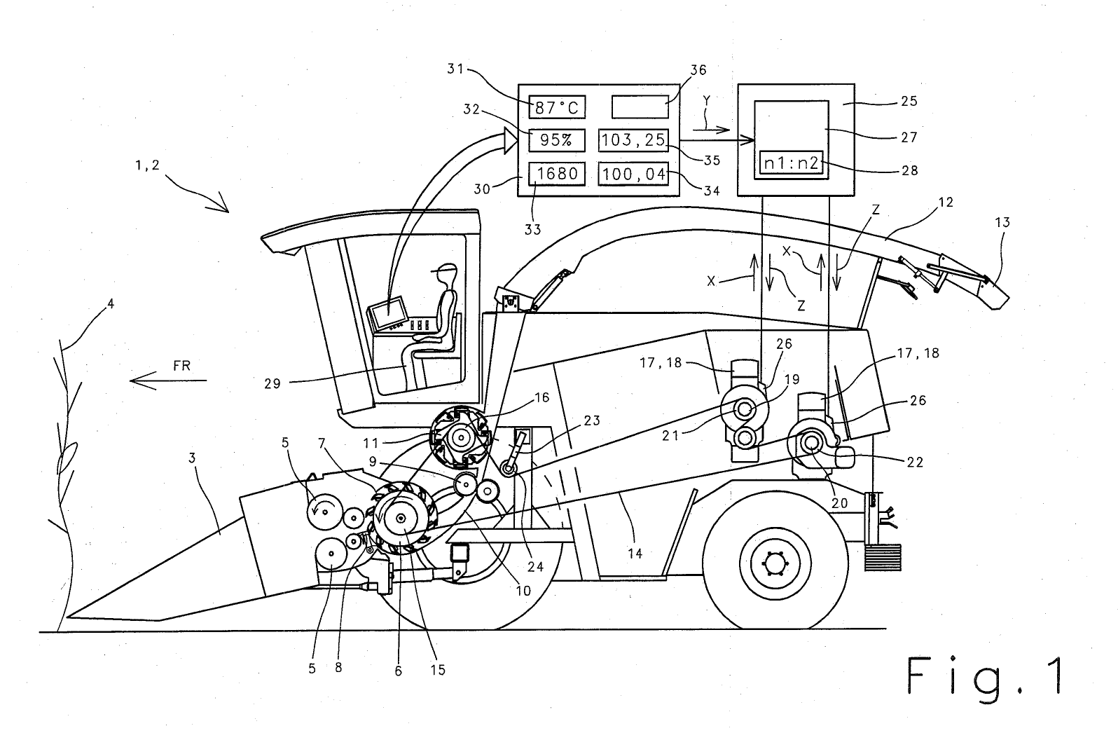

FIG. 1 shows a side view and a sectional view of a motor vehicle 2 which can be used for agricultural applications and which is designed as a self-propelled forage harvester 1. A front attachment 3 is assigned to the front, as viewed in the direction of travel FR, which picks up crop material 4 during the working operation of forage harvester 1, and which may fragmentize it, then guide it to downstream intake and pre-compression rollers 5. Intake and pre-compression rollers 5 guide crop material 4 to downstream, rotating chopper drum 6, the cutter blade 7 of which fragmentizes crop material 4 at a shear bar 8. Fragmentized crop material 4 is subsequently transferred to a post-fragmentation device 9 which pounds the crop grains, e.g., corn, and transfers them via a conveyer chute 10 to a post-accelerator 11. Post-accelerator 11 accelerates fragmentized crop material 4 and conveys it—via a horizontally and vertically displaceable upper discharge chute 12 and an upper discharge chute flap 13 assigned thereto such that it can swivel, in order to regulate the distance the crop material stream is thrown—toward a not-shown transport device assigned to upper discharge chute 12.

In the exemplary embodiment shown, chopper drum 6 and post-accelerator 11 are connected via the same drive belt 14 and pulleys 15, 16 assigned thereto with two drive units 17, 18 designed as diesel engines of the same or different performance classes. Clutches 19, 20—which are known per se and are therefore not described in greater detail—are assigned to the drive units, thereby allowing drive units 17, 18 to be engaged or disengaged in a manner to be described in greater detail. In the exemplary embodiment shown, clutches 19, 20 are integrated directly in pulleys 21, 22 assigned to drive units 17, 18. To transfer the drive energy without slip, drive belt 14 is always pre-tensioned by one or more tensioning devices 23 using idler pulleys 24. In addition, in a manner which is known per and is therefore not depicted, front attachment 3, intake and pre-compression rollers 5 upstream of chopper drum 6, and post-fragmentation device 8 are driven by drive units 17, 18.

According to FIG. 1, an electric motor-driven, electrohydraulic, or electronic control device 25 is assigned to agricultural motor vehicle 2, control device 25 being designed and connected with drive units 17, 18 such that it can record the operating period of individual working units 17, 18 and store it in a manner that allows it to be called up. It is within the scope of the present invention for control device 25 to be coupled directly with engine controls 26 of drive units 17, 18, and for control device 25 to receive “operating-time signals” X and, based on this signals, to determine the number of hours for which individual drive units 17, 18 have been operating. Using an algorithm 27 stored in control device 25, inventive operating-hour ratio 28 is determined based on the operating hours of individual working units 17, 18; inventive operating-hour ratio 28 is nothing more than a comparison of the operating hours of drive units 17, 18 with each other, and the determination of the extent to which the operating hours of one drive unit 17, 18 exceed or fall short of the operating hours of the other drive unit 17, 18.

Agricultural motor vehicles typically include a display unit 30 which is located within operator's 29 sight, and which can display highly diverse operating parameters of drive units 17, 18. In the exemplary embodiment shown, display unit 30 includes an “engine temperature” display field 31, an “oil fill level” display field 32, and an “engine speed” display field 33. The parameters visualized in these display fields are generated in a manner which is known per se and is therefore not depicted. Given that this information is transmitted as input signals Y to control device 25, wear-relevant criteria such as “engine temperature” 31, “oil fill level” 32, and “engine speed” 33 can be taken into account in the determination of operating hours and, therefore, inventive operating-hours ratio 28. “Engine temperature” 31, “oil fill level” 32, and “engine speed” 33, therefore, are the additional drive-specific state information according to the present invention, which is taken into account in the determination of operating-hours ratio 28. It is within the scope of the present invention that a “fuel consumption” field could also be provided, so that fuel consumption can also be used as drive-specific state information.

According to FIG. 1, display unit 30 can be designed such that the operating hours of each drive unit 17, 18 can be visualized in one operating-hours display field 34, 35, and operating-hours ratio 28 of the at least two drive units 17, 18 can be visualized in one display field 36. Depending on the design of displays 34 through 36, it is possible to provide bar diagrams or numerical data, such as presenting the operating hours as numbers, or presenting the operating-hours ratio as a percentage. In this manner, operator 29 of motor vehicle 2 is informed about the number of operating hours that drive units 17, 18 have worked, and he can control the engagement and disengagement of drive units 17, 18 such that—in a certain time period, which is intended to correspond to the service interval of drive units 17, 18—a nearly balanced operating-hours ratio 28 or a nearly identical number of operating hours results. In an advantageous embodiment of the present invention, a control signal Z—which turns particular drive units 17, 18 on or off—can be generated in control device 25 depending on the operating-hours ratio 28 or the operating hours. In this manner it is possible to make the start-up or shut-down of various drive units 17, 18 dependent on the number of operating hours already performed, and on the wear produced, which can be estimated based on various operating parameters.

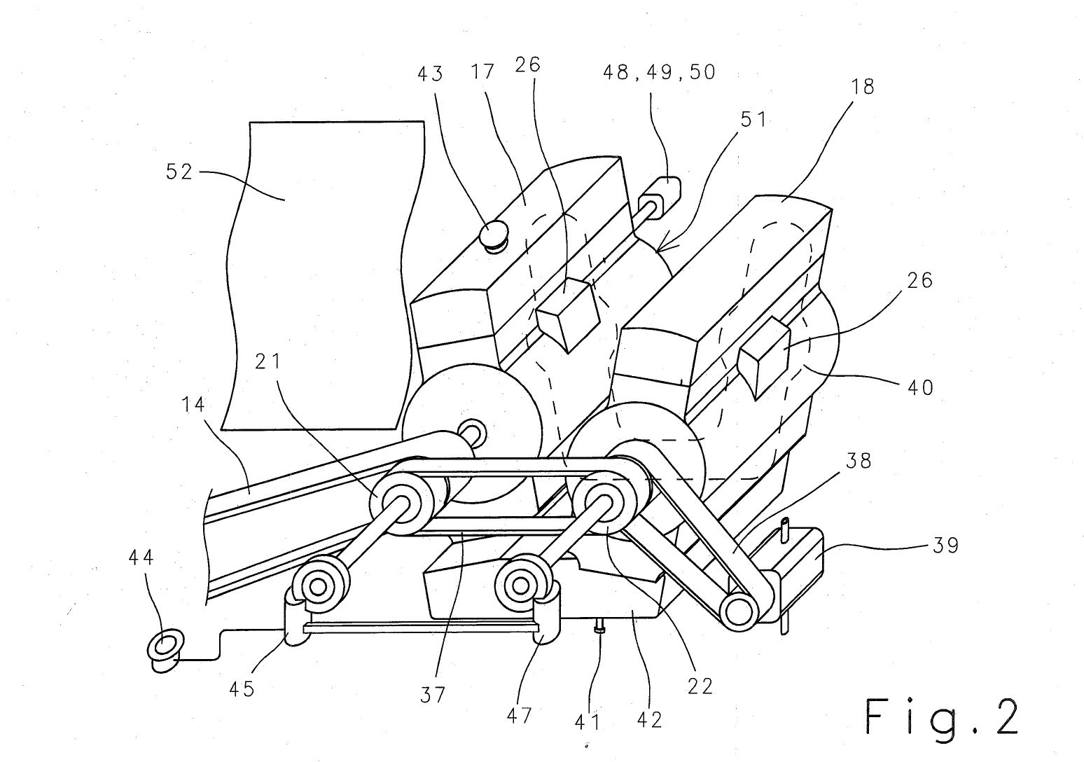

A design which minimizes wear and, therefore, service requirements is also attained when, as shown in FIG. 2, the at least two drive units 17, 18 form a “V” shape with each other. When drive units 17, 18 are also operated in synchronicity via their engine controls 26 such that the excitation created by individual drive units 17, 18 nearly cancel each other out, wear is minimized even further.

Given that drive units 17, 18 are positioned in parallel but axially offset, the two drive units 17, 18 can be coupled directly via a belt drive 37, and it is necessary to wrap only one of the pulleys 15, 16 of drive units 17, 18 with drive belt 14 described above. This has the advantage that, due to the spacial proximity of drive units 17, 18, it is possible to eliminate a strong redirection of drive belt 14, which would have to occur if drive belt 14 wrapped around both pulleys 21, 22. Given that a further drive train 38 is assigned to at least rear drive unit 18, it can also be ensured that this further drive unit 18 drives schematically depicted ground drive 39, while further drive unit 17 supplies working units 3, 5, 6, 9, 11 described above with drive energy. This results in a reduced load on each drive unit 17, 18, and allows a nearly balanced operating-hours ratio 28 to be attained.

Efficient and quick maintenance can also be attained when drive units 17, 18 share the same fuel supply. In one embodiment, this can be, e.g., engine circuit 40, by assigning one oil pan 41 or two interconnected oil pans 41 to several drive units 17, 18; oil pan 41 includes only one oil drainage device 42, such as an oil drainage screw. In addition, the two drive units 17, 18 have only one oil filler neck 43.

In addition, one starting device 44 can be assigned to the large number of drive units 17, 18, via which operator 29 of motor vehicle 2 starts one drive unit 17 in a manner known per se using a starter 45, while the other drive unit 18 is started by first drive unit 17. In the simplest case, this can take place in that belt drive 37 described above starts starter 47 of further drive unit 18, thereby starting drive unit 18.

Maintenance of drive units 17, 18 is simplified even further by the fact that, when further assemblies 48, such as directly driven hydropumps 49 or generators 50 assigned to drive units of this type, are adapted to drive unit 17, 18 which can be accessed directly. In the exemplary embodiment shown, this is attained by the fact that further assembly 48 is located on end face 51 of a drive unit 17, 18 closest to lateral covering 52 of motor vehicle 2.

Since agricultural motor vehicles must regularly provide a great deal of power while working in the field, and they can be operated in a low power range when driven on the road, it can also be provided in an advantageous operation on the road. The braking behavior of the motor vehicle is improved considerably as a result, and the original braking devices can be protected in a manner which minimizes wear and, therefore, the amount of service required.

It will be understood that each of the elements described above, or two or more together, may also find a useful application in other types of constructions differing from the types described above.

While the invention has been illustrated and described as embodied in an agricultural motor vehicle, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. An agricultural motor vehicle, comprising at least two drive units configured so that they are operatable separately or together in a drive train and outputting a same amount or different amounts of power, each of said drive units including means for recording operating hours, said at least two drive units being configured so that they have a substantially balanced operating-hour ratio within a certain time period.

2. An agricultural motor vehicle as defined in claim 1, wherein said means is configured to include a comparison of the operating hours of the at least two drive units, and a determination of the operating hours takes into account an operating period and drive-specific state information about a particular one of the drive units.

3. An agricultural motor vehicle as defined in claim 1, wherein said means is configured so that before a particular one of said drive units is started up, the operating-hour ratio of the at least two drive units is determined by comparing the operating hours of the particular working unit and, to attain a substantially balanced operating-hour ratio, based on the comparison and with consideration for a power required by the motor vehicle, and additional power is initially provided by the drive unit with fewer numbers of operating hours.

4. An agricultural motor vehicle as defined in claim 1, wherein when more power is required by the agricultural motor vehicle, both drive units are engagable and, when less power is required or when it can be supplied by one drive unit, a one drive unit or the at least two drive units which has fewer operating hours provides the power.

5. An agricultural motor vehicle as defined in claim 2, wherein said means is configured so that the drive-specific state information is an information selected from the group consisting of an engine speed, a fill level of an engine oil, a fuel consumption, and a engine temperature.

6. An agricultural motor vehicle as defined in claim 1, wherein said at least two drive units are configured as diesel engines having same or different power classes.

7. An agricultural motor vehicle as defined in claim 1, wherein said at least two drive units form a “V” shape with each other and include a synchronizing drive.

8. An agricultural motor vehicle as defined in claim 1, wherein said at least two drive units are positioned such that they are offset axially and in parallel.

9. An agricultural motor vehicle as defined in claim 1; and further comprising means for controlling a balancing of the operating-hour ratio of said drive units and selected from the group consisting of a display unit for controlling manually by an operator of the motor vehicle and an electronic control unit for controlling automatically using sensors.

10. An agricultural motor vehicle as defined in claim 1; and further comprising means for providing a time period corresponding to a service interval specified by a manufacturer of said drive units.

11. An agricultural motor vehicle, comprising at least two drive units operatable separately or together in a drive train and each capable of outputting a same amount or different amounts of power, each of said drive units including means for recording operating hours; a user interface and display unit; and a control device, said control device being connected via a data transmission system with drive-state sensors and/or control devices which contain drive-state data, and said user interface and display unit displaying the operating hours of a particular one of said drive units and/or the operating-hour ratio of said at least two drive units.

12. An agricultural motor vehicle as defined in claim 11, wherein the agricultural motor vehicle is configured as a forage harvester having working units, one of said drive units being configured for operating said working units, while the other of said drive units being configured to form a ground drive of the motor vehicle.

13. An agricultural motor vehicle as defined in claim 12, wherein said working units include a chopper drum, a post-fragmentation device, a post-accelerating device, and an intake conveyor mechanisms.

14. An agricultural motor vehicle as defined in claim 11; further comprising a same fuel supply, said at least two drive units being configured to share said same fuel supply.

15. An agricultural motor vehicle as defined in claim 14, wherein said fuel supply includes at least an engine oil circuit, and whereby one oil filler neck and one oil drainage device are assigned to said at least two drive units.

16. An agricultural motor vehicle as defined in claim 11; further comprising a starting device assigned to one of said at least two drive units, while the other of said drive units is configured so as to be started by said one drive unit which was started by said starting device.

17. An agricultural motor vehicle as defined in claim 11, wherein said at least two drive units are configured such that assemblies which are service-intensive and are adapted directly to at least one of said drive units are located on the drive unit that can be accessed directly.

18. An agricultural motor vehicle as defined in claim 12, wherein one of said drive units drives said working units and/or said ground drive, while the other of said at least two drive units supports a braking function of the motor vehicle.
